(19) United States
(12) Patent Application Publication
(10) Pub. No.: US 2025/0267387 A1
(43) Pub. Date: Aug. 21, 2025

(54) ADEL (AMBROSE DIAPHONIC EAR LENS) AUDIO COUPLING AND ISOLATION SYSTEM: IN-EAR MONITOR, EARBUD TIP, HEARING AID TIP, HEARING PROTECTION, AND ADJUSTABLE ISOLATION

(71) Applicant: Stephen Ambrose, Longmont, CO (US)

(72) Inventors: Stephen Ambrose, Longmont, CO (US); Cole Hammer, Littleton, CO (US); Susan Patterson, Berthoud, CO (US); Garnet Ambrose, Longmont, CO (US)

(21) Appl. No.: 19/057,801

(22) Filed: Feb. 19, 2025

Related U.S. Application Data
(60) Provisional application No. 63/555,241, filed on Feb. 19, 2024.

(51) Int. Cl. H04R 1/10; H04R 25/00

(52) U.S. Cl. CPC H04R 1/1016; H04R 1/1091; H04R 25/656

(57) ABSTRACT

The revised and expanded patent claims for an ear tip device focus on its versatility and advanced features. The device is designed for a universal fit in the user's ear, enabling safer listening at lower sound levels. It boasts an innovative sound delivery mechanism through a novel coupling method. Additionally, it incorporates a self-inflating mechanism that uses the body's natural deformation. The design includes an expansion area to adjust for jaw movements, enhancing the fit. An auto-deflation feature activates when the device is removed from the ear, and a safety valve regulates internal pressures to maintain comfort. The device is flexible, making it compatible with a wide range of personal listening devices and hearing aids. This adaptability emphasizes its universal application for various ear tips.

### CROSS REFERENCE TO RELATED APPLICATIONS

This application claims benefit to provisional patent application No. 63/555,241, entitled “ADEL (AMBROSE DIAPHONIC EAR LENS) AUDIO COUPLING AND ISOLATION SYSTEM: IN-EAR MONITOR, EARBUD TIP, HEARING AID TIP, HEARING PROTECTION, AND ADJUSTABLE ISOLATION”, filed Feb. 19, 2024, the entire contents of which are incorporated by reference in their entirety for all purposes.

### FIELD OF THE INVENTION

The present invention pertains to an ear tip device designed for a universal fit in the user's ear, enabling safer listening at lower sound levels. It boasts an innovative sound delivery mechanism through a novel coupling method. Additionally, it incorporates a self-inflating mechanism that uses the body's natural deformation. The design includes an expansion area to adjust for jaw movements, enhancing the fit. An auto-deflation feature activates when the device is removed from the ear, and a safety valve regulates internal pressures to maintain comfort. The device is flexible, making it compatible with a wide range of personal listening devices and hearing aids. This adaptability emphasizes its universal application for various ear tips.

### BACKGROUND OF THE INVENTION

The Ambrose Diaphonic Ear Lens (ADEL) system introduces multiple innovations in in-ear device technology, addressing long-standing issues such as dynamic ear sealing, occlusion effects, comfort, and sound fidelity. Below is an evaluation of the importance of this invention, followed by a breakdown of its key intellectual properties that should be prioritized for patent protection.

With the invention of the professional in-ear, stage and studio, monitoring systems in 1965, by Stephan D. Ambrose, large numbers of people began to experience the sealing of high fidelity speakers to the ear canal for the first time. These devices have protected hundreds of thousands of amateur and professional musicians and sound engineers from hearing loss due to excessive performance volumes. Nevertheless, in-ear monitors have been, and remain, a persistent source of audio fatigue and potential short term or long term hearing loss. They share this problem with other in-ear listening devices such as hearing aids, insert headphones, ear buds, and the like, as well as headphones and other over-ear devices that are designed to hold small loudspeakers in place close to a user's ears. Professional applications of in-ear monitors have called for some musicians and sound engineers to tolerate conditions of persistent audio fatigue, in which peoples' ears begin to physically ache or hurt after prolonged use of in-ear devices, which can become nearly intolerable by the end of a performance or recording session. These users often refer to a sensation of percussiveness beating their ears that cannot be eliminated by simply turning down the volume.

Almost every person has experienced a situation where the volume from another person's headphones could be heard even from across a room, on a bus, in a store, or any number of public venues. Given the sound volume necessary to be heard at a distance, the volume blasting directly into a listener's ear in such a situation can be expected to be excessive. The listener might be asked (or admonished) to turn down their headphones for the sake of their own health and for the courtesy to others, but what has not been hitherto widely realized is that the person listening to the headphones has already, unknowingly turned down their own personal perception of the volume through a natural hearing protection mechanism known as the acoustic reflex. The acoustic reflex is a natural mechanism involving an involuntary muscle contraction that occurs in the middle ear in response to high-intensity sound stimuli. By way of the acoustic reflex, contraction of the stapedius muscle in the ear reduces the ear's sensitivity in order to protect itself from being damaged by loud noises and to widen its dynamic range to higher sound pressure levels.

The persistent triggering of this reflex by insert headphones, hearing aids, and the like, may perpetuate a cycle in which the user continually increases the volume to counteract the effects of the acoustic reflex. This can also set up an additional dangerous situation for a user who is already tolerating very loud volumes due to the acoustic reflex and accidentally or intentionally turns the volume up even further at a point at which the stapedius muscle has already become exhausted or reached a limit of its inherent ability to protect the ear from loud sounds and temporary or even permanent hearing loss.

Unmet Need and Market Relevance. Traditional in-ear devices fail to adapt to jaw-induced mandibular deformations, leading to sound leakage (compromising fidelity), loss of seal (causing noise intrusion), reduced sound fidelity due to inefficient coupling, and user discomfort and pain (due to pressure inconsistencies). ADEL solves this by dynamically adjusting its seal in real time through a novel self-inflating airbag system that compensates for jaw motion. Applications in hearing protection, professional in-ear monitors (IEMs), hearing aids, and consumer audio represent a broad commercial impact.

Technical Superiority. One advantage of ADEL is that it utilizes a passive, mechanical operation requiring no external power, differentiating it from battery-dependent active noise-canceling systems. Another advantage is dual-functionality as a hearing restoration tool by reducing in-ear volume requirements, thereby lowering risk of hearing damage. The occlusion effect (a common issue in closed-fit earpieces) is mitigated with ADEL. Further, ADEL has seamless device insertion, retention, and removal mechanisms, addressing comfort and usability.

Scientific Validation & Commercial Viability. The technology behind ADEL is supported by major research institutions (e.g., VU, NSF-sponsored tests, NIH hearing aid studies). ADEL has been adopted and field-tested by world-renowned musicians and audio professionals and has restored the careers and hearing of high-profile celebrities, proving real-world efficacy.

Known ear tips and devices are not satisfactory for the range of applications in which they are employed. Some ear tips and devices exist, such as U.S. Pat. No. 8,391,534 to Ambrose et al., U.S. Pat. No. 8,526,652 to Ambrose et al., and U.S. Pat. No. 8,737,635 to Ambrose et al., European Publication No. 2559261 to Ambrose et al., the entire contents of which are incorporated herein by reference in their entirety by reference for all purposes. The current invention is an improvement of previous ear tips and devices and there is a need for such improvement.

ADEL aims to enhance auditory experiences by providing a dynamic seal and amplification of sound in the ear canal. Traditional methods of sealing the ear canal, such as foam ear tips or static ear molds, often fail to adapt dynamically to changing ear canal dimensions due to jaw motion, leading to sound leakage and discomfort. This invention addresses these issues by harnessing mandibular deformation caused by jaw motions to dynamically inflate an ePTFE airbag within the ear canal, thereby maintaining a secure and adaptive seal.

### SUMMARY OF THE INVENTION

The present invention surrounds a system that utilizes the patented inflatable ADEL Membrane for a universal ear fit, enhancing listening safety at lower volumes. Research at Vanderbilt University and user trials by Asius Technologies confirm that this technology allows for louder and better sound at lower measured volumes, with users reporting reduced listening fatigue and even hearing recovery.

The invention comprises an innovative mechanism that utilizes jaw motion to inflate an ePTFE airbag positioned between the first and second bends of the ear canal. The inflation is driven by mandibular deformation, which compresses three radially arranged pump bulbs housed in an ear tip behind the airbag. These pump bulbs are strategically positioned to efficiently transfer mechanical energy from jaw movements into the inflation system, dynamically adjusting the airbag's pressure and size.

This invention combines an adaptive inflation system powered by mandibular deformation with a stretch-activated deflation mechanism. The ePTFE airbag is mounted on a flexible tube that houses the air channel connecting the pump bulbs and the airbag. Upon removal of the device from the ear canal, the flexible tube stretches, creating a controlled venting pathway. This pathway allows inflation pressures to release, deflating the airbag without requiring additional user action.

Additionally, it incorporates a self-inflating pump mechanism that uses the body's natural deformation of the user's ear canal to maintain optimal canal-sealing pressurization of the inflated bubble membrane. Because of this, actions like talking, singing, and chewing cause the pump inflation chamber to contract and expand together with the canal wall deformations to achieve a continually comfortable canal sealing pressure within the bubble. The design also includes an expansion area to adjust for jaw movements, enhancing the fit by absorbing excessive pressures and refilling the bubble as needed. An auto-deflation feature activates when the device is removed from the ear. The action of withdrawing the inflated bubble from within the retaining anatomical contours of the canal walls extends the silicone bubble mounting tube, thereby uncovering a safety valve feature that also regulates internal pressures and maintains a comfortable bubble pressurization seal when closed.

This technology represents a paradigm shift in in-ear hearing and audio devices. Its biomechanically adaptive design solves a decades-old problem, making it a high-value intellectual property with strong commercial potential. The device is flexible, making it compatible with a wide range of personal listening devices and hearing aids. This adaptability emphasizes its universal application for various ear tips.

### BRIEF DESCRIPTION OF THE DRAWINGS

A complete understanding of the present invention may be obtained by reference to the accompanying drawing, when considered in conjunction with the subsequent detailed description, in which:

FIG. 1 is a sectional view of an ear tip device wherein the airbag is inflated;

FIG. 2 is a sectional view of an ear tip device wherein the airbag is deflated;

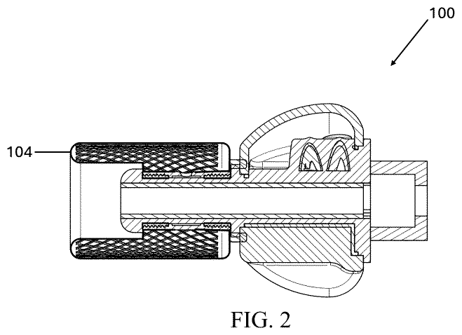

FIG. 3 is a perspective view of an ear tip device attached to a full-range Speaker for use as an In-Ear Monitor;

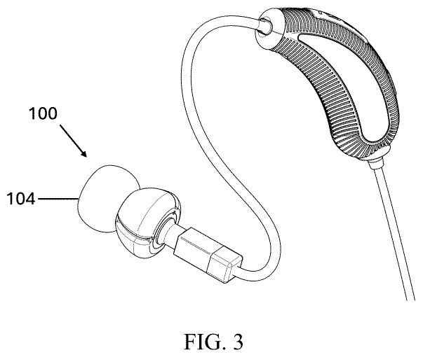

FIG. 4 is a perspective view of an ear tip device attached to a Medically prescribed or over-the-counter Hearing Aid;

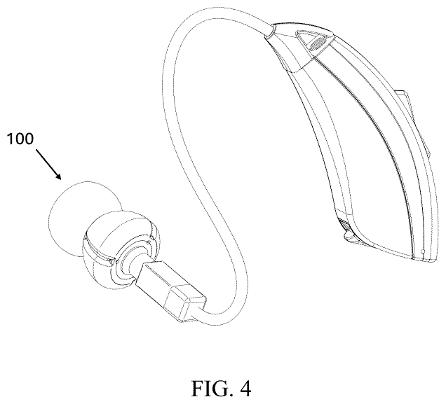

FIG. 5 is a side view of an ear tip device attached to a consumer earbud-style personal listening device;

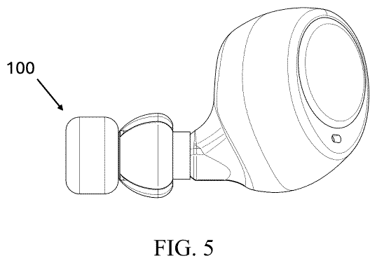

FIG. 6 is a perspective view of an ear tip device attached to an insertable part for adjustable ambiance hearing protection;

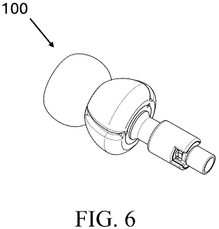

FIG. 7 is a side view of an ear tip device attached to a consumer earbud-style personal listening device;

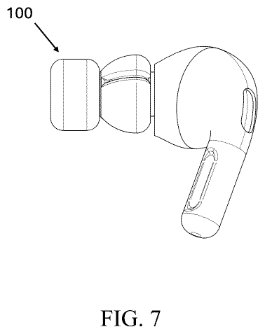

FIG. 8 is a sectional view of an ear tip device;

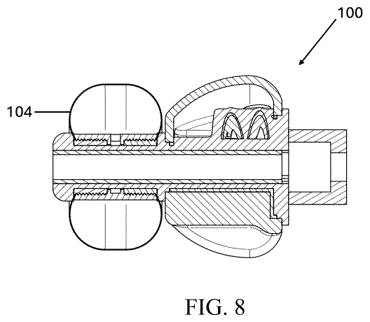

FIG. 9 is a perspective view of insertable clips that fit different personal listening devices and hearing aids; and

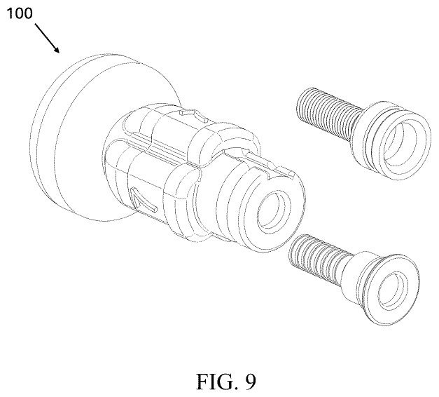

FIG. 10 is a perspective view of an ear tip device with annular valves, attached to an insertable screw-type mechanism part for adjustable ambiance hearing protection.

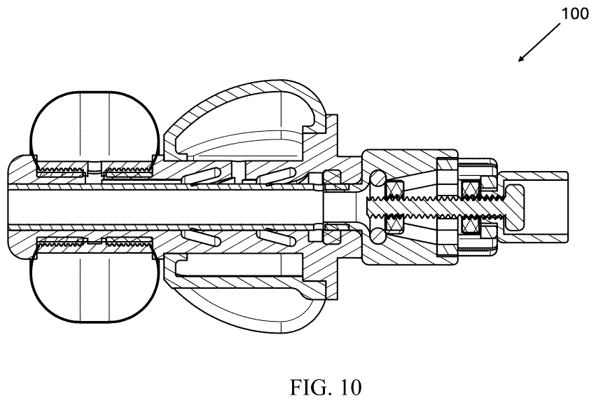

Like reference numerals refer to like parts throughout the several views of the drawings.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

The ADEL Audio Coupling and Isolation System focuses on its safety and advanced features. The device is designed for a universal fit in the user's ear, enabling safer listening at lower sound levels. It boasts an innovative sound delivery through a novel coupling method.

Jaw-Actuated Inflation Mechanism. The jaw-actuated inflation mechanism harvests mandibular deformation to power airbag inflation via three radially placed pump bulbs strategically positioned to compress in response to jaw movements, with no external power source required-fully biomechanical operation. This eliminates need for external power, dynamically adapting to ear canal changes.

Dynamic ePTFE Airbag System. Self-inflating ePTFE airbag that adjusts in real time to ear canal deformation which is positioned between the first and second bends of the ear canal for optimal acoustic sealing. A pressure-adaptive expansion chamber ensures consistent seal and internal pressure stability which provides adaptive sealing and prevents discomfort.

Dual-Stage Inflation Mechanism. Partial inflation occurs upon insertion of the device. Full inflation completes via jaw motion, pressure on the external anatomy of the ear canal (finger pushing on outside of ear), or pressure on the device itself, optimizing user control and reducing manual adjustments. This enhances the user experience and reduces the need for manual adjustments. Differentiates from static ear seals.

Pressure Absorption and Reintroduction Mechanism (Expansion Chamber Mechanism). The extensible silicone sound tube substrate absorbs excess pressure from additional jaw-induced ear canal deformations and reintroduces stored pressure into the airbag as the jaw relaxes, ensuring consistent airbag inflation. This maintains stable airbag pressure without overinflation, which is essential for comfort and effectiveness.

Stretch-Activated Deflation Mechanism. A passive deflation exists upon device removal, wherein the airbag-mounted flexible tube stretches, opening a controlled venting pathway, which allows internal pressure to escape, automatically deflating the airbag for easy extraction. This enables effortless removal of the device with mechanical simplicity and usability.

Exhaust-Assisted Device Removal Mechanism. Redirects airbag pressure release into an exhaust port within the sound tube. Generated airflow helps dislodge the sealed airbag from the ear canal and reduces discomfort and difficulty in removing in-ear devices. Uses released pressure to ease extraction. Air can exhaust outside the ear canal or inside the ear canal and outside the sound tube or inside the sound tube.

Insertion-Activated Inflation Function. Compression of pump bulbs during insertion forces air into the airbag. User achieves a preliminary seal before mandibular inflation completes the process.

Integrated Sound Pressure Relief System. Ingress port in the sound tube channels excess in-ear insertion pressure into the airbag which relieves pressure on the eardrum while simultaneously assisting airbag inflation. This balances internal ear pressures, aiding inflation, creating a unique hearing protection feature. Three pressures exists, pneumatic inflation, acoustic sound, and pneumatic sound, which absorbs into the bubble for tissue conduction in the canal wall and is much better than bone conduction with more efficiency for low volumes.

Acoustic and Physiological Enhancements. Hearing restoration properties include lower volume requirements that reduce the risk of long-term hearing damage, improved tissue-conducted sound measurement accuracy, and superior noise isolation without excessive pressure buildup, addressing hearing protection needs.

### Components.

ePTFE Airbag. A thin, biocompatible, and elastic airbag made from expanded polytetrafluoroethylene (ePTFE) is designed to inflate within the ear canal. It is positioned between the first and second bends of the ear canal, or even proximal to the tympanic membrane, and the airbag provides a customizable seal that adapts to jaw movement and canal shape changes.

Pump Bulbs. Three small, radially arranged pump bulbs are integrated into the ear tip housing behind the airbag. These pump bulbs are positioned to compress in response to mandibular deformation of the ear canal during jaw motion. Each bulb contains a one-way valve system to control airflow direction. Multiple pumps allow for small displacement. It will be appreciated by a person having ordinary skill in the art that one or more pumps are available for the same function.

Mandibular Deformation Transfer System. The ear tip is designed to couple with the natural deformation of the ear canal caused by jaw motion. A soft, flexible interface ensures comfort while transmitting the deformation force effectively to the pump bulbs.

Airflow Pathways and One-Way Valves. The pump bulbs are connected to the ePTFE airbag via small airflow channels. One-way valves ensure that air moves from the pump bulbs into the airbag during compression but does not flow back during relaxation. In certain embodiments, the one way valve may comprise a duckbill valve, annular valve, or any other type of valve that may be appreciated by a person having ordinary skill in the art.

Pressure Regulation Mechanism. A micro-pressure release valve is integrated into the system to prevent over-inflation and maintain optimal ear canal pressure for comfort and safety.

### Operation.

Mandibular Deformation Capture. As the user opens and closes their jaw, the deformation of the ear canal applies pressure to the ear tip housing. This force compresses the radially positioned pump bulbs, initiating the inflation process. Jaw motion compresses the pump bulbs, transferring air through the egress check valves into the ePTFE airbag. The airbag inflates dynamically to conform to the ear canal's changing dimensions.

Air Transfer to Airbag. Air from the pump bulbs flows through the one-way valves and into the ePTFE airbag. The airbag inflates dynamically, conforming to the ear canal's changing dimensions and maintaining an effective seal.

Dynamic Adjustment. During jaw relaxation, the pump bulbs return to their original shape, drawing in ambient air through secondary one-way intake valves. This cyclic process allows continuous adaptation to jaw motions.

Pressure Regulation. The pressure release valve ensures that the airbag does not over-inflate, protecting the user from discomfort or damage to the ear canal.

Bubble Over-pressurization Absorption and Re-inflation Expansion Chamber Mechanism. An extensible bubble pressure absorption and re-pressurization chamber is formed between the outer sound tube wall and its housing sleeve which supports the mounted bubble and through which inflation pressures flow from the radial pump(s). The enclosed sound tube is extensible and compresses radially upon over-pressurization of the bubble thereby absorbing over-pressurizations within the ear canal due to mandibular deformations. Upon relaxation of the jaw, the absorbed air is reintroduced into the bubble without reliance on pressure generation by the radial pump(s).

Stretch-Activated Deflation. Withdrawing the device from the ear stretches the tube upon which the airbag mounting sleeve is positioned, thereby allowing inflation pressures to leak out of the airbag upon removal of the device from the ear canal. This deformation activates the venting pathway, opening a slit or valve that allows the airbag's internal pressure to escape. The airbag deflates completely as air leaks out through the venting pathway. The process is seamless, requiring no additional user input. Upon removal and release of the device, the tube returns to its original shape, closing the venting slit or valve and resetting the system for future use.

In some models inside the inflatable ADEL membrane is a mesh spring that elongates the material eliminating excess material.

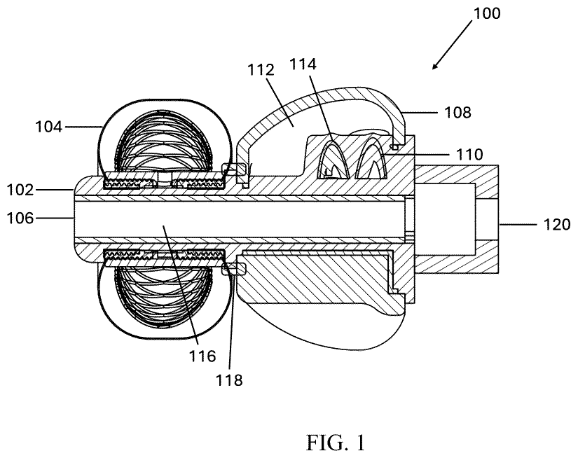

In a preferred embodiment, as seen in FIG. 1 the ear tip device 100 comprises a base 102 capable of positioning proximate a user's ear canal with a bubble 104 attached to the base 102 that is capable of inflation and deflation, with a sound tube 106 for delivering air to the bubble 104 during inflation of the bubble 104, with at least one of a pump bulb 108 for delivering inflating air to the bubble 104 during inflation of the bubble 104, with at least one one-way ingress valve 110 for delivering inflating air one direction through the sound tube 106, wherein the bubble 104 automatically extends into the user's ear canal, conforming to the user's ear canal, during inflation and retracts from the user's ear canal during deflation. Certain embodiments comprise a self-inflating mechanism 112 that uses the body's natural deformation by the pumping area remaining in contact with the canal walls of the ear. In certain embodiments, air is forced out of the egress valve 114 when the ear canal is constricted and the air is replenished through the ingress valve 110 when the ear canal is relaxed.

In certain embodiments, the bubble 104 is substantially cylindrical. In certain embodiments, the bubble 104 automatically inserts into the ear canal on inflation and is inflated by a self-inflating mechanism 112 that utilizes the body's natural deformation for inflation and an auto-deflation feature that activates upon being pulled from the ear

Certain embodiments include an expansion area 116 specifically designed to accommodate jaw motions, thereby complimenting the fit in the user's ear.

Certain embodiments include an expansion area 116 to adjust for jaw movements, enhancing the fit because of the one-way valve between this area and the pumping mechanism air causes this area to expand.

Certain embodiments include an auto-deflation feature that activates when the ear tip device 100 is removed from the ear. This is a result of the sealing area underneath the bubble stretching and the diameter being reduced. This area also functions as a safety valve 118 regulating internal pressures to maintain comfort by deforming under excessive pressure.

In certain embodiments, the ear tip device 100 is made out of Silicone, making it compatible with a wide range of personal listening devices and hearing aids. This adaptability emphasizes its universal application for various ear tips.

Certain embodiments comprise a coupling area 120 capable of coupling with different personal listening devices and hearing aids. Other embodiments of the ear piece device are capable of acting as an ear plug to deafen sound. Certain embodiments have a screw type mechanism that allows for more or less noise to be transferred through the sound tube to the ear.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when compositions of matter are claimed, it should be understood that compounds known and available in the art prior to Applicant's invention, including compounds for which an enabling disclosure is provided in the references cited herein, are not intended to be included in any composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of,” and “consisting of” may be replaced with either of the other two terms. The invention illustratively described herein suitably may be practiced in the absence of any element or elements, limitation or limitations which is not specifically disclosed herein.

The terms “first,” second,” “top,” “bottom,” etc., as used herein, are intended for illustrative purposes only and do not limit the embodiments in any way. Additionally, the term “plurality,” as used herein, indicates any number greater than one, either disjunctively or conjunctively, as necessary, up to an infinite number. Further, “Providing” an article or apparatus, as used herein, refers broadly to making the article available or accessible for future actions to be performed on the article, and does not connote that the party providing the article has manufactured, produced, or supplied the article or that the party providing the article has ownership or control of the article.

One of ordinary skill in the art will appreciate the art within the drawings and can employ various alterations to the design within those presented. The drawings are exemplary of a design and are illustrative of the invention but should not be construed to create limitations of the invention. The invention in the drawings suitably may be practiced in variations without departure from the spirit of the invention.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. An ear tip device, comprising:
a base capable of positioning proximate a user's ear canal;
a bubble attached to the base that is capable of inflation and deflation;
a sound tube for delivering inflating air to the bubble during inflation of the bubble;
at least one of a pump bulb for delivering inflating air to the bubble during inflation of the bubble;
at least one of a one-way valve for delivering inflating air one direction through the sound tube; and
wherein the bubble automatically extends into the user's ear canal, conforming to the user's ear canal, during inflation and retracts from the user's ear canal during deflation.

2. The ear tip device of claim 1, wherein the bubble is substantially cylindrical.

3. The ear tip device of claim 1, wherein the bubble automatically inserts into the ear canal on inflation.

4. The ear tip device of claim 1, wherein the bubble is inflated by a self-inflating mechanism that utilizes the body's natural deformation for inflation.

5. The ear tip device of claim 1, wherein the device includes an expansion area specifically designed to accommodate jaw motions, thereby complimenting the fit in the user's ear.

6. The ear tip device of claim 1, wherein an auto-deflation feature that activates upon being pulled from the ear.

7. The ear tip device of claim 1, further comprising a coupling area capable of coupling with different personal listening devices and hearing aids.
